(19) United States
(12) Patent Application Publication
(10) Pub. No.: US 2015/0100819 A1
(43) Pub. Date: Apr. 9, 2015

(54) Method of Recovering Data in a Storage Device

(71) Applicants: Andrey Fedorov, St. Petersburg (RU); Aleksei Marov, St. Petersburg (RU)

(72) Inventors: Andrey Fedorov, St. Petersburg (RU); Aleksei Marov, St. Petersburg (RU)

(21) Appl. No.: 14/045,600

(22) Filed: Oct. 3, 2013

(51) Int. Cl. G06F 11/14

(52) U.S. Cl. CPC G06F 11/1402
USPC 714/6.12

(57) ABSTRACT

A method and system for recovering data written onto a storage device when system failure and/or damage occur during use is provided. A memory of the storage device is divided into a plurality of information zones, for storing data as a codeword set, and a plurality of check zones, for storing checksums, of equal size selected from different parts of the storage device. A computing unit calculates etalon checksums with an established formula during each write data operation for each codeword set in the information zones. If failure, damage or data corruption occurs, computing unit calculates current checksums using an established formula. The values of the stored etalon checksums and the current checksums are used for data recovery, which is performed by solving the system of equations, received from the formula for computing the checksums. Parallel calculation schemes are used in checksum computing and for data recovery.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to fault tolerant data storage systems, and more particularly to a method and system for recovering data written onto a storage device if system failure, damage or data corruption of the storage device occurs during its use.

### DISCUSSION OF RELATED ART

Disk storage is the primary storage medium for most systems. Systems operate in real time and loss of data on a disk drive can cause the system to fail and may have significant non-recoverable impact on the functions supported by the system. A fault-tolerant, or recoverable, storage system is one that permits recovery of original data even in the event of partial system failures. Existing data storage systems may utilize different techniques in connection with providing fault tolerant data storage systems in the event of a data storage device failure. To improve data reliability, many computer systems implement a redundant array of independent disks (RAID) system, which is a disk system that includes a collection of multiple disk drives that are organized into a disk array and managed by a common array controller. The array controller presents the array to the user as one or more virtual disks. There are many standard methods referred to as RAID levels (RAID 0 to RAID 6) for distributing data across the physical hard disk drives in a RAID system.

Conventional RAID levels have their advantages and disadvantages. RAID 0 (Striped Disk Array without Fault Tolerance) provides data striping (spreading out blocks of each file across multiple disk drives) but no redundancy. This improves performance but does not deliver fault tolerance. If one drive fails then all data in the array is lost. RAID 1 (Mirroring and Duplexing) provides disk mirroring (replicating all data on two separate disks). If one drive fails, critical information can still be accessed from the mirrored drive. Although failure tolerance is high, the utilization efficiency of the disks is extremely low. RAID 2 (Error-Correcting Coding) stripes data at the bit level rather than the block level and is rarely used. RAID 3 (Bit-Interleaved Parity) provides byte-level striping with a dedicated parity disk. It cannot service simultaneous multiple requests, and is rarely used. RAID 4 (Dedicated Parity Drive) provides block-level striping (like RAID 0) with a parity disk. If a data disk fails, the parity data is used to create a replacement disk. A disadvantage to RAID 4 is that the parity disk can create write bottlenecks.

RAID 5 (Block Interleaved Distributed Parity) provides data striping at the byte level and also stripe error correction information. A level 5 RAID system provides a high level of redundancy by striping both data and parity information across a plurality of disks. This results in excellent performance and good fault tolerance. Accordingly, even if any one of the disks fails, the original complete data can be restored from the data and parity information of the disks other than that. However, restoration is impossible when two or more units thereof fail at the same time.

RAID 6 (Independent Data Disks with Double Parity) is similar to RAID 5 (striped parity) except instead of one parity block per stripe there are two. With two independent parity blocks, RAID 6 can survive the loss of two disks in the group. However, the utilization efficiency is lower than RAID 5 by an amount corresponding to one disk since two parities are generated. In a level 6 RAID system, two syndromes referred to as the P syndrome and the Q syndrome are generated for the data and stored on hard disk drives in the RAID system. The P syndrome is generated by simply computing parity information for the data in a stripe (data blocks (strips), P syndrome block and Q syndrome block). The generation of the Q syndrome requires Galois Field (Finite Field) multiplications and is complex in the event of a disk drive failure. Traditional processors have poor performance with computations in the Galois Field hence creating a computational bottleneck. The regeneration scheme is typically performed using lookup tables for computation or through the use of a plurality of Galois-field multipliers which are limited to a specific polynomial. This is performed through pipeline processing which is an inherently slow serial process.

In some existing storage systems a method and apparatus to compute a Q syndrome for RAID 6 through the use of Advanced Encryption Standard (AES) operations is provided. In an embodiment, the result of Galois Field multiplication performed using the AES operations allows RAID 6 support to be provided without the need for a dedicated RAID controller. The process of performing a Galois Field multiplication operation in parallel on each of a plurality of bytes in a block of bytes, comprises performing an AES Mix Columns transformation on the block of bytes having all even position bytes set to zero to provide a first result; performing the AES Mix Columns transformation on the block of bytes having all odd position bytes set to zero, to provide a second result; and combining the first result and the second result to provide the result of the Galois Field multiplication operation. This process is complicated and takes significant time.

Some other storage systems provide an acceleration unit that offloads computationally intensive tasks from a processor. The acceleration unit includes two data processing paths each having an Arithmetic Logical Unit and sharing a single multiplier unit. Each data processing path may perform configurable operations in parallel on a same data. Special multiplexer paths and instructions are provided to allow P and Q type syndromes to be computed on a stripe in a single-pass of the data through the acceleration unit. However, the calculation of the syndromes is a pipeline process which is inherently slow.

Furthermore, some distributed data storage devices, comprises a controller unit configured to read a configuration matrix that assigns a plurality of data storage devices to a plurality of data storage clusters. The plurality of data storage clusters is configured to store a plurality of data symbols. A calculator is configured to compute a plurality of checksums of the data symbols stored in the data storage devices such that at least one intermediate or partial checksum is computed for each of the data storage clusters. A communication fabric is configured to distribute the checksums to each of the data storage clusters. While the use of intermediate checksum symbols can reduce the computational burden and latency for the error correction calculations, they increase the computational and data-storage-capacity costs.

Accordingly, none of the existing fault-tolerant data storage systems provide parallel computing which significantly increases the checksum calculation and data recovery speed if failure, damage or data corruption of the storage device occurs. It is essential that certain modifications should be performed for the existing fault-tolerant data storage systems to decrease the checksum calculation complexity and increase the calculation speed.

Therefore, there is a need for a new method and storage system for recovering data written onto a storage device used due to system failure or damage. The new method would allow parallel computing thereby significantly increasing the checksum calculation and data recovery speed. Such a method would reduce the checksum calculation complexity and allow the use of simpler devices than the center 64 Intel architecture processor as a computing unit, for example, a computer graphics card. Moreover, the method would be adaptable to be used with any type of storage device. The present disclosure accomplishes these objectives.

### SUMMARY OF THE DISCLOSURE

The present embodiment is a method and system for recovering data written onto a storage device when system failure or damage or data corruption occurs during use. The system comprises a storage device and a computing unit. While implementing the method, a memory of the storage device is divided into a plurality of information zones of equal size selected from different parts of the storage device and a plurality of check zones selected from different parts of the storage device. The computing unit may be a part of the storage device or external to the storage device.

The plurality of information zones is configured to write data thereto as a set of codewords with identical number of information. At least one codeword from the set of codewords is written into at least one of the plurality of information zones. The computing unit defines a pair of etalon checksums with an established formula for each set of codewords with identical number of information in the plurality of information zones during each write operation in the storage device. Parallel calculations schemes are used in checksum computing for the codeword array.

The plurality of check zones is configured to store the pair of etalon checksums. The pair of etalon checksums for each set of codewords with identical number of information is written as a codeword with the same number of information into the plurality of check zones. If failure, damage or data corruption occurs during the use of the storage device, a pair of current checksums is calculated by the computing unit, with an established formula, for at least one set of codewords with identical number of information in the plurality of information zones where the damage has occurred. The values of the pair of current checksums and the stored pair of etalon checksums are used for data recovery.

The computing unit performs data recovery by solving a system of equations received from the established formula for computing the pair of etalon checksums and the pair of current checksums. The number of equations in the system depends on the number of failed or damaged storage areas. The computing unit uses parallel calculation scheme for data recovery. The use of parallel calculation scheme increases the checksum calculation speed and the data recovery speed.

In a preferred embodiment, the storage device may be a disk array with level 6 RAID (redundant array of independent disks) architecture. The proposed method for recovering data may also be applied to other types of storage devices, for example, those based on flash memory, or to the disk array using non-RAID-6 number of checksums. In the case of using a disk array as the storage device, constructed from a hard disk according to RAID-6 technology, the disks are divided into blocks of equal length. The sequence of blocks with the same numbers, but located on different disks, forms a stripe. Information zones and check zones are blocks of one stripe that are stored on different disks. RAID-6 uses two storage checksums to recover up to two failed drives.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 illustrates a storage system in accordance with a preferred embodiment of the present invention;

FIG. 2 is a flow chart illustrating a method for recovering data written onto a storage device in accordance with the preferred embodiment the present invention;

FIG. 3 illustrates an embodiment of a RAID-6 hard disk array showing a plurality of stripes with each stripe including data blocks;

FIG. 4 illustrates a general scheme of calculation algorithms for checksum computation and data recovery in accordance with a preferred embodiment of the present invention;

FIG. 5 illustrates a circular feedback shift register used for Galois field multiplication in accordance with a preferred embodiment of the present invention;

FIG. 6 illustrates a parallel calculating scheme for multiple elements of a Galois field in accordance with a preferred embodiment of the present invention;

FIG. 7 illustrates a summation of two data blocks of information zones of a storage device in accordance with a preferred embodiment of the present invention;

FIG. 8 illustrates multiplication by primitive element x of a data block in an information zone in accordance with a preferred embodiment of the present invention;

FIG. 9 illustrates a parallel calculating scheme in Intel 64 architecture with a 256-bit YMM register;

FIG. 10 illustrates a summation of two data blocks with a 256-bit YMM register; and

FIG. 11 illustrates multiplication by primitive element x of a data block in an information zone with a 256-bit YMM register.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. As such, the present invention may take the form of an entirely hardware embodiment, an entirely software embodiment, or an embodiment combining software and hardware aspects. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

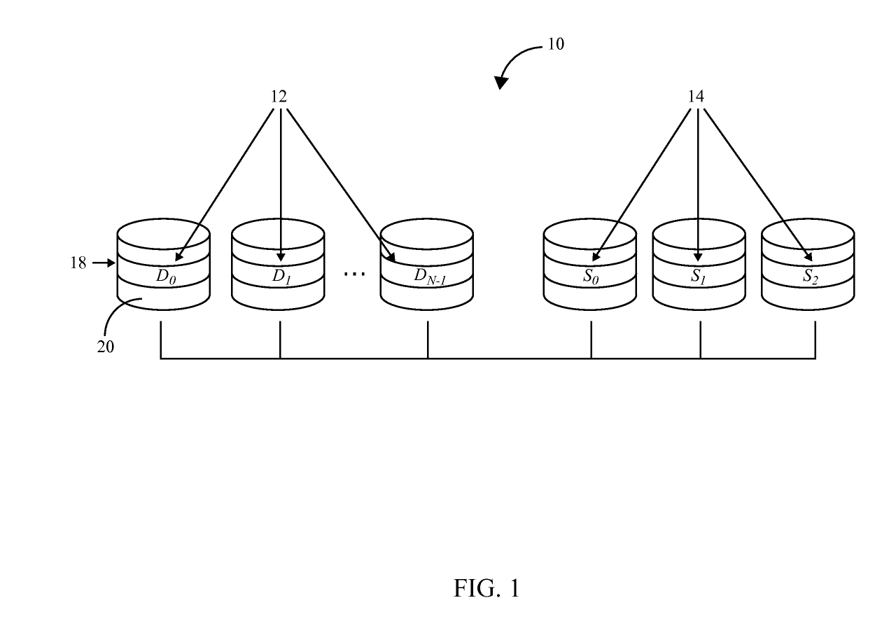

FIG. 1 illustrates a storage device 10 in accordance with a preferred embodiment of the present invention. The present invention is a method and system for recovering data written onto a storage device when system failure or damage or data corruption occurs during use. According to the preferred embodiment, the system comprises a storage device 10 and a computing unit (not shown). While implementing the method, a memory of the storage device 10 is divided into a plurality of information zones 12 of equal size selected from different parts of the storage device 10 and a plurality of check zones 14 also selected from different parts of the storage device 10. The computing unit may be a part of the storage device 10 or external to the storage device 10.

The plurality of information zones 12 is configured to write data thereto as a set of codewords with identical number of information. At least one codeword from the set of codewords is written into at least one of the plurality of information zones 12. The data to be written are considered by the computing unit as an array of vectors, wherein the elements of the array are equal to the bits of the codewords. The computing unit defines a pair of etalon checksums with an established formula for each set of codewords with identical number of information in the plurality of information zones 12 during each write operation in the storage device 10. Parallel calculations schemes are used in checksum computing for the codeword array.

The plurality of check zones 14 is configured to store the pair of etalon checksums. The pair of etalon checksums for each set of codewords with identical number of information is written as a codeword with the same number of information into the plurality of check zones 14. The data is written as a codeword array and their corresponding pair of etalon checksums is stored in separate zones of the storage device 10.

If failure, damage or data corruption occurs during the use of the storage device 10, a pair of current checksums is calculated by the computing unit, with an established formula, for at least one set of codewords with identical number of information in the plurality of information zones 12 where the damage has occurred. The values of the pair of current checksums and the stored pair of etalon checksums are used for data recovery. The computing unit performs data recovery by solving a system of equations received from the established formula for computing the pair of etalon checksums and the pair of current checksums. The number of equations in the system depends on the number of failed or damaged storage areas. The computing unit uses parallel calculation scheme for data recovery. The use of parallel calculation scheme increases the checksum calculation speed and the data recovery speed.

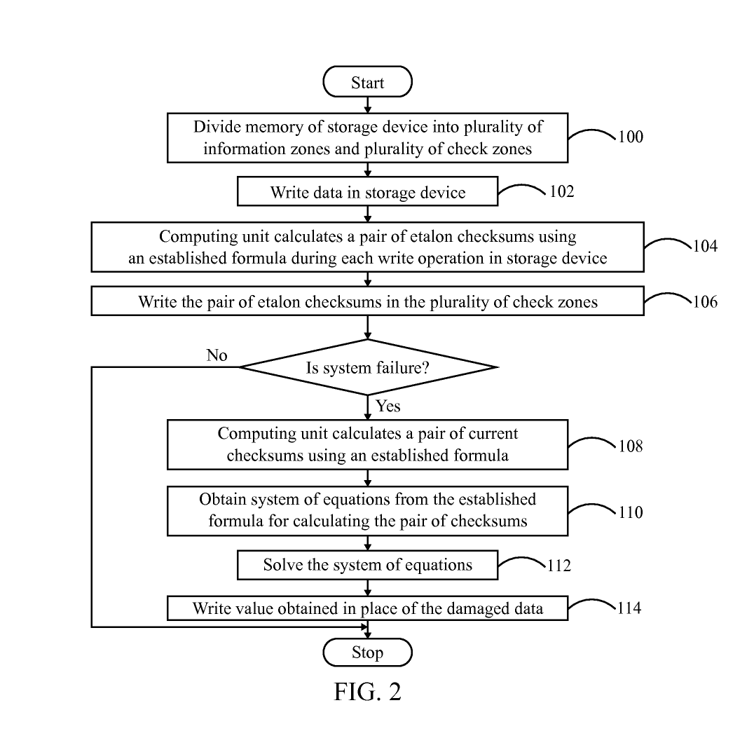

FIG. 2 is a flow chart illustrating a method for recovering data written onto the storage device 10 in accordance with the preferred embodiment the present invention. The method for recovering data according to the present invention comprises, dividing a memory of the storage device 10 into the plurality of information zones 12 of equal size selected from different parts of the storage device 10 and the plurality of check zones 14 selected from different parts of the storage device 10 as shown at block 100. Data is written onto the storage device 10 as a set of codewords with identical number of information in the plurality of information zones 12 wherein at least one codeword is written in at least one of the plurality of information zones 12, as shown at block 102. A pair of etalon checksums is calculated using an established formula during each write operation in the storage device 10 by a computing unit for the set of codewords with identical number of information in the plurality of information zones 12, as shown at block 104. The pair of etalon checksums for each set of codewords with identical number of information is written as a codeword with the same number of information in the plurality of check zones 14, as shown at block 106. A pair of current checksums is calculated using an established formula by the computing unit for at least one set of codewords with identical number of information in the plurality of information zones 12 when a system failure occurs, as shown at block 108. A system of equations is obtained from the established formulas for calculating the pair of etalon checksums and the pair of current checksums, wherein a number of equations in the system depend on the number of failed or damaged storage areas, as shown at block 110. The system of equations is solved for recovering the failed or damaged data, as shown at block 112. Finally, a value obtained by solving the system of equations is written in place of the damaged data, as shown at block 114.

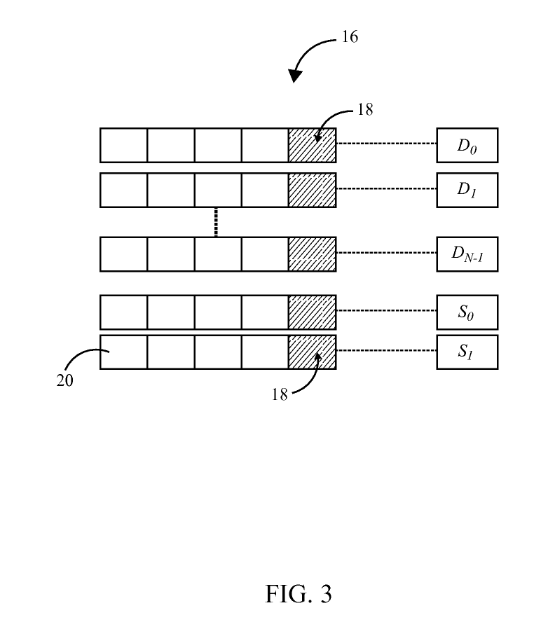

FIG. 3 illustrates an embodiment of a RAID-6 hard disk array 16 showing a plurality of stripes 18 with each stripe including data blocks 20. The proposed method for recovering data can be used for any storage device 10. In the case of using a disk array 16 as the storage device 10, constructed from a hard disk according to RAID-6 (redundant array of independent disks) technology, the disks are divided into blocks 20 of equal length. The sequence of blocks 20 with the same numbers, but located on different disks, forms a stripe 18. Information zones 12 and check zones 14 are blocks 20 of one stripe 18 that are stored on different disks. RAID-6 uses two storage checksums or syndromes to recover up to two failed drives. The proposed method may also be applied to other types of storage devices, for example, those based on flash memory, or to disk arrays using non-RAID-6 number of checksums or syndromes.

Data to be written in the storage device 10 is considered as elements of a Galois field GF (2ⁿ). The Galois field GF (2ⁿ) is a finite field of 2ⁿ polynomials with binary coefficients of a degree not exceeding n−1. The data is written in a 16-hexadecimal notation. For example:

x⁷+x⁵+x²+1→10100101→A5

x⁵+x³+1→101001→29

For any n a GF field (2ⁿ) can be built, with an irreducible polynomial f of degree n. Such a polynomial is called generator polynomial. In Galois field the addition operation is defined as an addition of polynomials of modulo 2, and the multiplication operation as multiplication of the generator polynomial modulus. That is, the result of multiplying of two polynomials is divided by the generator polynomial and the remainder of this division is the end multiplying result of two GF (2ⁿ) field elements. For example, polynomial 171 (x⁸+x⁶+x⁵+x⁴+1) may be selected as a generator polynomial for the (2ⁿ) field.

The operation of addition in field GF (2ⁿ) will be the same and does not depend on the choice of generator polynomial, since the sum degree cannot exceed the maximum degree of the summands. For example:

A5+29=8C

10100101+00101001=10001100

In case when the generator polynomial degree does not exceed the machine word, the field elements addition operation is performed in a single machine command of bit-wise exclusive or (XOR). The multiplication operation is performed in two stages. The elements of the field are multiplied as polynomials, and then the remainder of division of this product by the generator polynomial is calculated. For example:

A5×29=6A(mod 171)

In this case in terms of basic machine operations it is necessary to produce up to 2(n−1) additions depending on the value of the factors.

In the preferred embodiment, operations with Galois field elements (addition and multiplication) are used to calculate the checksums or syndromes in the storage device 10. In the case when RAID-6 technology is used to provide disk array fault tolerance, two checksums or syndromes are calculated. Data to be recorded are divided into blocks 20, the length of which is equal to the hard disk block length. The data to be recorded is written as a set of codewords with identical number of information in the plurality of information zones 12. Each codeword is written on one data block 20 in a stripe 18 on different disks. For these stripe blocks 20 a pair of etalon checksums S₀, S₁ are calculated with a computing unit according to the following formulas:

$${S}_{0} = {\sum }_{i = 0}^{N - 1} {D}_{i} = {D}_{0} + {D}_{1} + … + {D}_{N - 1}$$

$$\begin{matrix}{S}_{1} = {\sum }_{i = 0}^{N - 1} {D}_{i} {x}^{N - i - 1} \\ = {D}_{0} {x}^{N - 1} + {D}_{1} {x}^{N - 2} + … + {D}_{N - 1} \\ = ( ( ( {D}_{0} x + {D}_{1} ) x + {D}_{2} ) x + … + {D}_{N - 1} )\end{matrix}$$

Dᵢ is the i^{th} information zone, into which the codewords d_{i,1}, d_{i,2}, . . . , d_{i,s-1} are recorded, where i=0, . . . , N−1, and codewords are the elements of a Galois field. N is the number of information zones, s is the number of codewords in one information zone, and x is a primitive Galois field element.

Multiplying of the information zone Dᵢ by the primitive element of field x or its degrees is understood as the multiplication in modulus an irreducible polynomial of all information zone codewords by the primitive element of the field or its degree. Addition of two information zones Dᵢ and Dⱼ refers to the addition of the corresponding codewords of two information zones. The resulting pair of etalon checksum values is written to disk in the same stripe 18 as the corresponding data blocks 20.

When a storage device failure or damage occurs for a hard disk array 16, this means that the stripe block 20 corruption occurs on the stored disks. In the preferred embodiment, data recovery is performed by stripes 18. Data recovery is performed by solving a system of equations, obtained from the formulas for computing the checksums. The xᵢ coefficients in the formulas were chosen so that the system of equations always has a solution. Selecting the degrees of primitive element as the coefficients provides the fulfillment of this condition.

In the preferred embodiment, consider the case when one block 20 is damaged in a stripe 18. This corresponds to the failure of one disk in the array 16. If the damaged block 20 is in a check zone 14, then a current checksum, corresponding to the damaged check zone, is computed according to the established formula for computing the current checksums. The resulting checksum value is overwritten instead of the damaged value in the data block 20. If the damaged block 20 is in an information zone 12, then the hardware registers the failure. The current checksum, corresponding to the damaged information zone, is computed by skipping the value of the failed stripe block 20. If a Dⱼ block, where j is a number of the corrupted stripe block 20, is damaged, then the value of the current checksum is computed according to the following formula:

$${\hat{S}}_{1} = {\sum }_{{i = 0}_{i \neq j}}^{N - 1} {D}_{i} {x}^{N - i - 1} = {D}_{0} {x}^{N - 1} + {D}_{1} {x}^{N - 2} + … + {D}_{j - 1} {x}^{N - j} + {D}_{j + 1} {x}^{N - j - 2} + … + {D}_{N - 1}$$

Then the value of the failed stripe block 20 in the information zone 12 is computed by solving a system of equations, received from the established formula for computing the checksums. The value of the failed information zone is computed according to the following formula:

Dⱼ=(S₁+\dot{S}₁)x^{-(N-j-1)}

S₁ is the value of the stored etalon checksum and Ŝ₁ is the value of the current checksum. The resulting value is written in place of the damaged value in the data block 20.

The negative exponent means the inverse of Galois field element. Multiplication by the inverse element corresponds to the division in algebra. The calculation of the inverse field element requires a lot of computing resources. The inverse elements values are the most convenient to take from pre-calculated tables, or to reduce multiplication by the inverse element to multiplication by the degree of the primitive according to the Fermat's Theorem:

x^{-a}=x²^{ⁿ}^{-1-a}

2ⁿ is the number of elements of the used Galois field.

In an alternate embodiment, consider the case when two blocks 20 are damaged in a stripe 18. This corresponds to the failure of two disks in the array 16. This method of data recovery is also used if an unrecoverable reading error (UER) occurs during the reconstruction of one failed disk, and, therefore, two blocks 20 are damaged. If the damaged blocks 20, are both in the check zones 14, then the pair of current checksums, corresponding to the damaged check zones, are computed according to the established formulas for computing the checksums. The resulting checksum values are overwritten instead of the damaged values in the data blocks 20.

If one of the two damaged blocks 20 is a block of the information zone 12 and another is a block of the check zone 14, data is recovered according to the above described method for one failed unit, and the value of the damaged check zone is calculated according to the established formulas for computing the checksums.

If both the damaged blocks 20, are in the information zones 12, then the hardware registers the failure. The pair of current checksums is computed by skipping the values of the failed stripe blocks 20. If Dⱼ and Dₖ blocks, where j, k are the numbers of the corrupted stripe blocks 20, are damaged, then the values of the pair of current checksums Ŝ₀, Ŝ₁ are computing according to the following formulas:

$${\hat{S}}_{0} = {\sum }_{{i = 0}_{i \neq j , i \neq k}}^{N - 1} {D}_{i} = {D}_{0} + {D}_{1} + … + {D}_{j - 1} + {D}_{j + 1} + … + {D}_{k - 1} + {D}_{k + 1} + … + {D}_{N - 1}$$

$${\hat{S}}_{1} = {\sum }_{{i = 0}_{i \neq j , i \neq k}}^{N - 1} {D}_{i} {x}^{N - i - 1} = {D}_{0} {x}^{N - 1} + … + {D}_{j - 1} {x}^{N - j} + {D}_{j + 1} {x}^{N - j - 2} + … + {D}_{k - 1} {x}^{N - k} + {D}_{k - 1} {x}^{N - k - 2} + … + {D}_{N - 1}$$

Then the values of the failed information zones are computed by solving the system of equations, received from the formula for computing the checksums. The values of the failed information zones are computing according to the following formulas:

Dₖ=((S₁+Ŝ₁)x^{-(N-j-1)}+S₀+\dot{S}₀)[x^{j-k}+1]⁻¹

Dⱼ=S₀+\dot{S}₀+Dₖ

S₀, S₁ are the values of the stored pair of etalon checksums and Ŝ₀, Ŝ₁ are the values of the pair of current checksums. The resulting values are written in place of the damaged values in the data blocks 20.

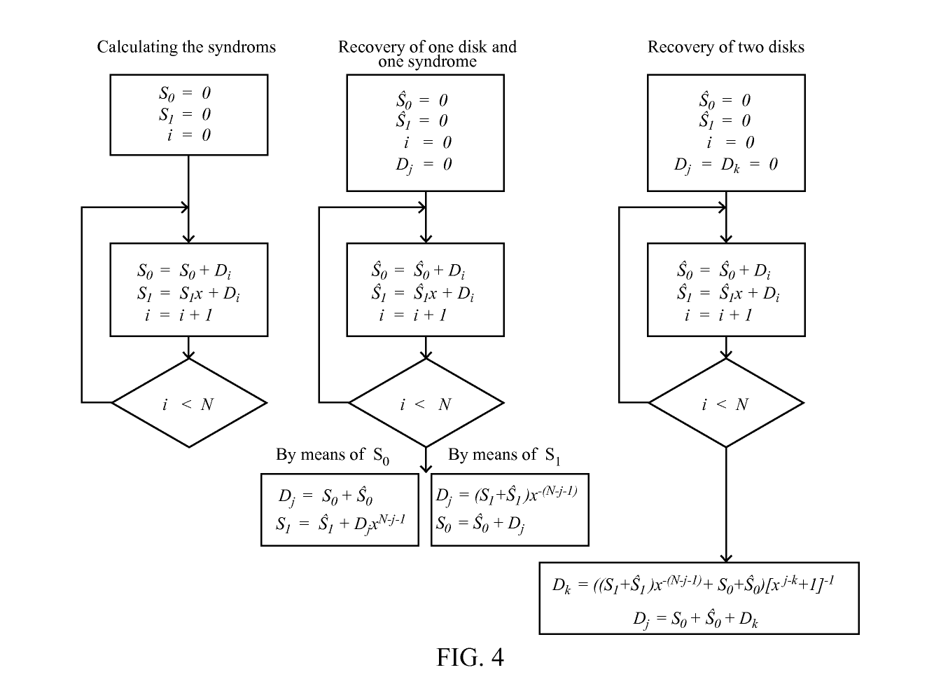

FIG. 4 illustrates the general scheme of calculation algorithms for checksum/syndrome computation and data recovery. It can be seen that the main algorithm complexity is in the cycles, in which the multiplication of the codewords by x and the codeword addition occurs. It is proposed to optimize these operations, due to their parallel execution with several elements simultaneously. The described data recovery method can also be used in Advanced Reconstruction mode.

The multiplication of two random elements of the Galois field both appears in formulas of one and two corrupted blocks reconstruction. But for polynomials of degree less than n the operation can be rewritten as follows:

a(x)b(x)=(aₙ₋₁xₙ₋₁+aₙ₋₂xⁿ⁻²+ . . . +a₁x+a₀)(bₙ₋₁xₙ₋₁+bₙ₋₂xⁿ⁻²+ . . . +b₁x+b₀)=((bₙ₋₁a(x)x+

Rewritten in this way, the operation is more convenient for software implementation, since it reduces to a sequence of multiplications by x and additions. This is convenient because the intermediate results are within the boundary of the machine word when calculating the product of polynomials in this manner.

The method of multiplication of a single codeword by x can be illustrated with the help of an example, GF (2⁸). The polynomial f=(x⁸+x⁶+x⁵+x⁴+1)=171 can be selected as the generator polynomial. Multiplication by a polynomial x is reduced to a shift operation by one bit to the left and adding the result to the module, if the shift resulted in a carry-over. For example:

A5×2=3B(mod 171)

25×2=4A(mod 171)

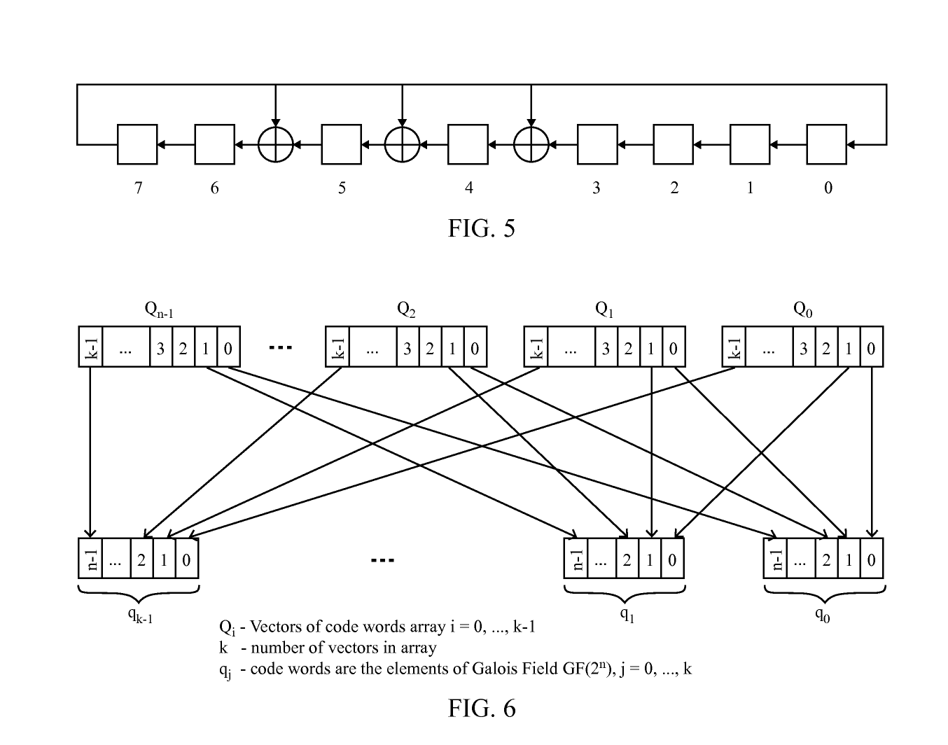

Multiplication by x is often depicted as a circular feedback shift register. FIG. 5 illustrates a circular feedback shift register used for Galois field multiplication. Each square represents the register bit to which the polynomial coefficient corresponding to the degree, equal to the number of the bit, is written. The arrows indicate the direction of shift register operation, when multiplying by x. In this case, if the most significant bit has the one, then due to the feedback it will be added to modulo two to the bits, corresponding to the generator polynomial unit coefficients, i.e. the addition of the multiplication by x result with the module, on which the field is built, will happen.

FIG. 6 illustrates a parallel calculating scheme for multiple elements of a Galois field in accordance with a preferred embodiment of the present invention. The data for which it is necessary to carry out multiplication by x or addition are considered as an array of vectors. The array size is n, where n is a generator polynomial degree. The vector length is equal to machine word length of the computing unit. Thus for Intel 64 architecture, 128-bit XMM registers can be used as these vectors if the processor supports streaming SIMD extensions (SSE) technology, or 256-bit YMM registers can be used, if the processor supports advanced vector extensions (AVX) technology. The bits with equal numbers are considered as elements of Galois field GF (2ⁿ). Thus, k codewords can be recorded simultaneously, where k is the array vector length or k*n bits of information.

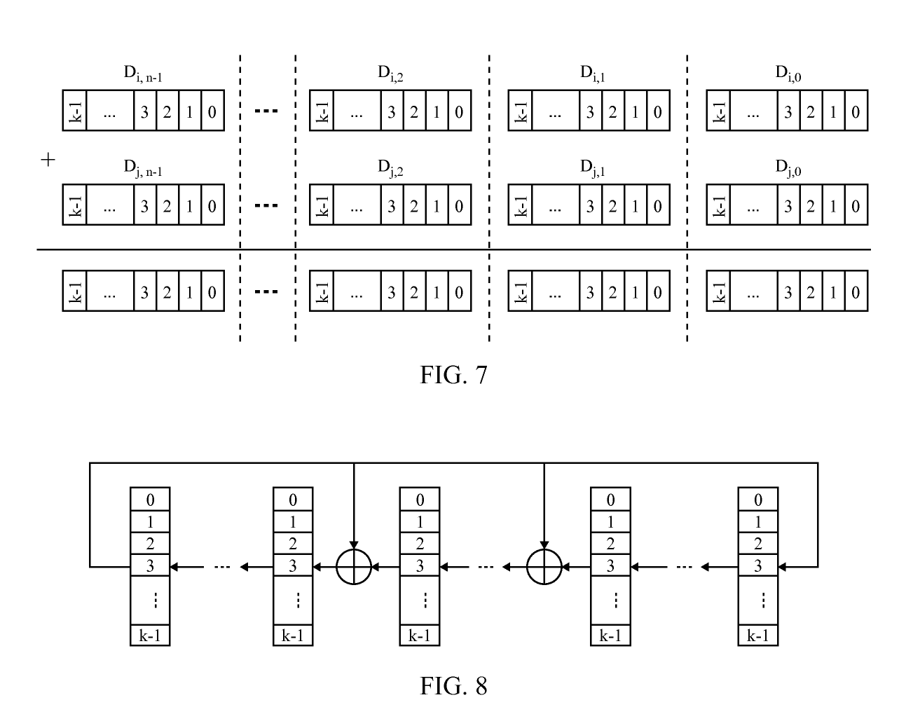

It is suggested that the length of one vector of codewords array is equal to the length of machine word of the computing unit. Then the operation of modulo 2 (XOR) addition of two vectors in the array corresponds to the operation of modulo 2 (XOR) addition of two machine words of a computing unit. This method of codewords representation allows performing an addition of two Dᵢ and Dⱼ blocks 20 of the information zones 12 of a storage device 10 as illustrated in FIG. 7. Thus, modulo 2 (XOR) addition of Dᵢ and Dⱼ blocks will be performed for n XOR operations by the computing unit that corresponds to the parallel addition of k−1 Galois field elements, since the length of one codewords array vector is equal to the length of machine word of the computing unit.

FIG. 8 illustrates multiplication by x of a data block 20 in an information zone 12. The figure illustrates the multiplication by x of the Dᵢ block, considered as the vectors array. Modulo-2 addition (XOR) is applied to the array vectors, the numbers of which are equal to single bits numbers in a GF (2ⁿ) field generator polynomial. Thus, (p−2) XOR computing operations, where p is the number of non-zero generating polynomial coefficients, is required to multiply (k−1) field elements by x, since the length of one codewords array vector is equal to the length of machine word of the computing unit. The array vector numbers can be changed instead of the cyclic vectors shift performance in this case.

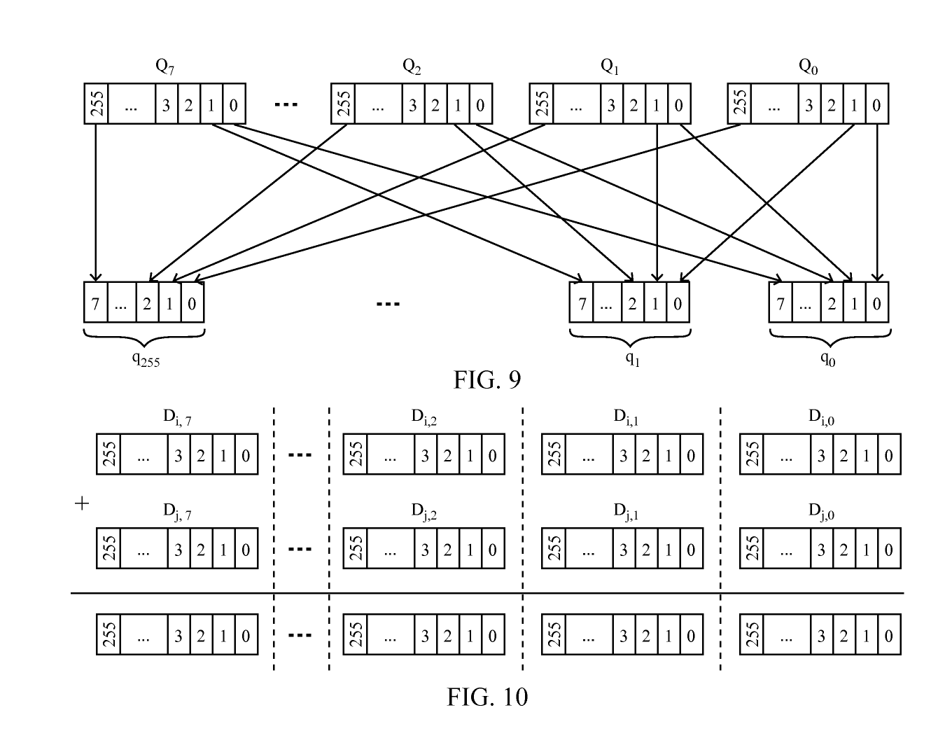

FIG. 9 illustrates the parallel calculating schemes in Intel 64 architecture with 256-bit YMM registers and GF (2⁸) Galois field from f=(x⁸+x⁶+x⁵+x⁴+1)=171 generator polynomial. Data as the field element, is arranged in a vectors array, enabling 256 GF (2⁸) field elements (256 bytes) to be recorded simultaneously.

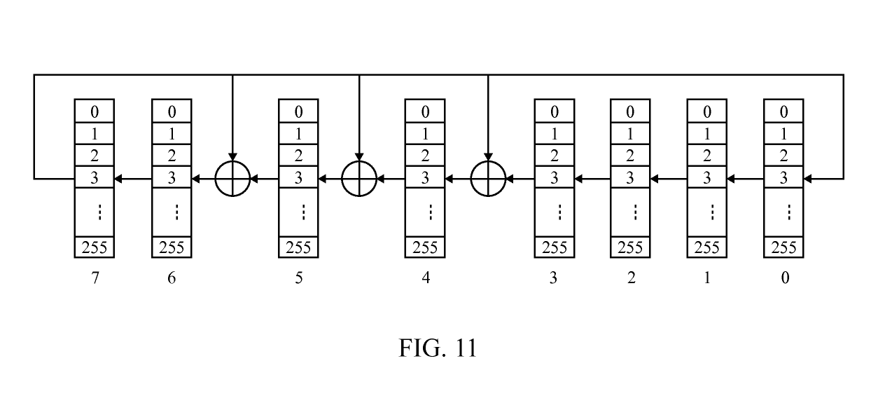

FIG. 10 illustrates a summation of two data blocks with a 256-bit YMM register. It is necessary to perform eight XOR operations with 256-bit YMM registers to sum 256 field elements from Dᵢ and Dⱼ blocks simultaneously. FIG. 11 illustrates multiplication by primitive element x of a data block in an information zone with a 256-bit YMM register. In order to multiple 256 field elements by x simultaneously, it is necessary to perform three XOR operations with 256-bit YMM registers and change the numeration of array vectors.

Thereby multiplication not by 2, but by any arbitrary Galois field element can be reduced to multiplications by x and additions. This means that the multiplication by an arbitrary Galois field element can be performed to k field elements at the same time. All operations for computing checksums and data recovery can be implemented using the parallel calculating schemes and the above mentioned formulas then.

In the present invention, the proposed method allows the parallel computing of k elements of GF (2ⁿ) field with machine word of k length. Hence the time taken by the computing unit for performing a number of operations decreases. This significantly increases the checksum calculation and data recovery speed due to parallel calculations, comparing with the methods where parallel computing is not used. In the coding mode proposed by the present invention, all calculations are reduced to elementary operations of transfer and bit-wise modulo 2 (XOR) addition, that allows using simpler devices than the center 64 Intel architecture processor as a computing unit, for example, a computer graphics card. The increase in check sum calculation speed and data recovery consequently improves the work of the storage device 10 as a whole.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A method for recovering data written onto a storage device when system failure and/or damage occurs during use, the method comprising:
(a) dividing a memory of the storage device into a plurality of information zones of equal size selected from different parts of the storage device and a plurality of check zones selected from different parts of the storage device;
(b) writing data onto the storage device, the data to be recorded being written as a set of codewords with identical number of information in the plurality of information zones wherein at least one codeword being written in at least one of the plurality of information zones;
(c) calculating a pair of etalon checksums using an established formula during each write operation in the storage device by a computing unit for the set of codewords with identical number of information in the plurality of information zones;
(d) writing the pair of etalon checksums for each set of codewords with identical number of information as a codeword with the same identical number of information in the plurality of check zones;
(e) calculating a pair of current checksums using an established formula by the computing unit for at least one set of codewords with identical number of information in the plurality of information zones when a system failure occur;
(f) obtaining a system of equations from the established formula for calculating the pair of etalon checksums and the pair of current checksums, wherein a number of the system of equations depending on a number of failed and/or damaged storage areas;
(g) solving the system of equations for recovering the failed and/or damaged data; and
(h) writing a value obtained by solving the system of equations in place of the damaged data.

2. The method of claim 1 wherein the computing unit may be a part of the storage device.

3. The method of claim 1 wherein the computing unit may be external with respect to the storage device.

4. The method of claim 1 wherein the computing unit uses parallel calculation scheme for calculating the pair of etalon checksums and the pair of current checksums, and for data recovery.

5. The method of claim 1 wherein the storage device may be a disk array with level 6 RAID (redundant array of independent disks) architecture.

6. A system configurable to recover data written onto a storage device when failure and/or damage occurs, the system comprising:
a storage device having a memory divided into a plurality of information zones of equal size selected from different parts of the storage device and a plurality of check zones selected from different parts of the storage device; and
a computing unit for recovering damaged data;
whereby the computing unit utilizes parallel calculation scheme for the calculation of damaged data thereby increasing data recovery speed.

7. The system of claim 6 wherein the computing unit may be a part of the storage device.

8. The system of claim 6 wherein the computing unit may be external with respect to the storage device.

9. The system of claim 6 wherein the plurality of information zones is configurable to write data thereto as a set of codewords with identical number of information.

10. The system of claim 6 wherein the computing unit defines a pair of etalon checksums with an established formula for each set of codewords with identical number of information in the plurality of information zones during each write operation in the storage device.

11. The system of claim 6 wherein the computing unit defines a pair of current checksums with an established formula for at least one set of codewords with identical number of information in the plurality of information zones when failure and/or damage of the storage device occur.

12. The system of claims 10 and 11 wherein the plurality of check zones is configurable to store the pair of etalon checksums and the pair of current checksums thereto.

13. The system of claim 12 wherein the computing unit performs data recovery by solving a system of equations received from the established formula for computing the pair of etalon checksums and the pair of current checksums.

14. The system of claim 12 wherein the computing unit uses parallel calculation scheme for calculating the pair of etalon checksums and the pair of current checksums and for data recovery.

15. The system of claim 6 wherein the storage device may be a disk array with level 6 RAID (redundant array of independent disks) architecture.

16. A computer readable storage medium having a computer readable program, wherein the computer readable program when executed on a computer causes the computer to:
(a) divide a memory of a storage device into a plurality of information zones of equal size selected from different parts of the storage device and a plurality of check zones selected from different parts of the storage device;
(b) write data onto the storage device, the data to be recorded being written as a set of codewords with identical number of information in the plurality of information zones wherein at least one codeword being written in at least one of the plurality of information zones;
(c) calculate a pair of etalon checksums using an established formula during each write operation in the storage device by a computing unit for the set of codewords with identical number of information in the plurality of information zones;
(d) write the pair of etalon checksums for each set of codewords with identical number of information as a codeword with the same identical number of information in the plurality of check zones;
(e) calculate a pair of current checksums using an established formula by the computing unit for at least one set of codewords with identical number of information in the plurality of information zones when a system failure occur;
(f) obtain a system of equations from the established formula for calculating the pair of etalon checksums and the pair of current checksums, wherein a number of the system of equations depending on a number of failed and/or damaged storage areas;
(g) solve the system of equations for recovering the failed and/or damaged data; and
(h) write a value obtained by solving the system of equations in place of the damaged data.

17. The computer readable storage medium of claim 16 wherein the computing unit may be a part of the storage device.

18. The computer readable storage medium of claim 16 wherein the computing unit may be external with respect to the storage device.

19. The computer readable storage medium of claim 16 wherein the computing unit uses parallel calculation scheme for calculating the pair of etalon checksums and the pair of current checksums and for data recovery.
